(19) United States
(12) Patent Application Publication
(10) Pub. No.: US 2018/0290106 A1
(43) Pub. Date: Oct. 11, 2018

(54) SYSTEM AND METHODS OF PROCESSING LIQUID THEREIN

(71) Applicant: Purdue Research Foundation, West Lafayette, IN (US)

(72) Inventor: Tillmann C. Kubis, West Lafayette, IN (US)

(73) Assignee: Purdue Research Foundation, West Lafayette, IN (US)

(21) Appl. No.: 15/944,776

(22) Filed: Apr. 3, 2018

Related U.S. Application Data
(60) Provisional application No. 62/481,109, filed on Apr. 3, 2017.

(51) Int. Cl. B01D 61/42; B01D 71/02; B01D 69/06

(52) U.S. Cl. CPC B01D 61/425; B01D 71/021; B01D 2325/021; B01D 2311/2603; B01D 2325/26; B01D 69/06

(57) ABSTRACT

A system includes a plurality of nanoporous filtering media, wherein each nanoporous filtering media of the plurality of nanoporous filtering media includes a plurality of nanopores, wherein the plurality of nanoporous filtering media are stacked over each other. The system further includes a voltage source connected to a nanoporous filtering media of the plurality of nanoporous filtering media, wherein the voltage source is configured to provide a voltage to the nanoporous filtering media of the plurality of nanoporous media, wherein the voltage source is configured to establish an electrostatic charge within a circumference of each nanopore of the plurality of nanopores of the nanoporous filtering media.

The present U.S. Patent Application is related to and claims the priority benefit of U.S. Provisional Patent Application Ser. No. 62/481,109, filed Apr. 3, 2017, the contents of which is hereby incorporated by reference in its entirety into this disclosure.

### TECHNICAL FIELD

The present application relates to liquid filtration systems, and more specifically, to a system and method for providing water filtration using electrostatically controlled nanopores in a thin film.

### BACKGROUND

According to the UN World Water Development Report of 2015, there is an increasing urgency in providing drinkable water. UNESCO states that “[l]ack of water supply, sanitation and hygiene (WASH) takes a huge toll on health and well-being and comes at a large financial cost, including a sizable loss of economic activity. In order to achieve universal access, there is a need for accelerated progress in disadvantaged groups and to ensure non-discrimination in WASH service provision. Investments in water and sanitation services result in substantial economic gains; in developing regions the return on investment has been estimated at US$5 to US$28 per dollar. An estimated US$53 billion a year over a five-year period would be needed to achieve universal coverage—a small sum given this represented less than 0.1% of the 2010 global GDP.” Given about 97% of our planet's water is sea water, the sea water desalination should obviously be the most promising technology to fully solve the “WASH” problem for all humans—irrespective of their economical situation. The reason why sea water desalination does not play a relevant role in the world's fresh water supply lies in the high energy costs that traditional desalination requires. Note that the theoretically best energy efficiency for desalination is so far predicted to be about 1.3 kWh/m³ using reverse osmosis systems. This is still very high compared to the typical energy consumption for local fresh water supply (like pumping ground water) of (sometimes much) less than 0.2 kWh/m³. One of the biggest challenges of reverse osmosis systems is to find durable, permeable and still filter-efficient membranes.

In this context, nanopores, i.e. well defined holes that are regularly distributed in thin (2D) materials (mono- or few atomic layers of 2D materials or ultrathin bodies made of 3D materials) have been studied as possible filtration devices. These systems utilize the fact that salt ions in water are surrounded by a shell of water molecules (“hydration shell”). Due to the ions' charge and water molecules attracted by that charge, the salt ions are effectively larger than free water molecules. Pores of small enough diameter (predicted in the order of a nanometer) block salt ions to pass but are still permeable for water molecules. Other objects in the water (e.g. viruses, bacteria or even bulkier contaminations) are filtered in such a nanopore membrane as well.

Conventional technologies face limitations: very thin pores cannot be expected to have a high water flow. This results in a low overall effectiveness. More complex systems, such as pores coated with ion-selective materials are expensive and difficult to produce and require longer than few-atom thick channels to maintain the desired charge-filtering effect. Therefore, improvements are needed in the field.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. It is emphasized that, in accordance with standard practice in the industry, various features may not be drawn to scale and are used for illustration purposes only. In fact, the dimensions of the various features in the drawings may be arbitrarily increased or reduced for clarity of discussion.

FIG. 1 illustrates a filtering media according to one or more embodiments.

FIG. 2 illustrates one embodiment of the present disclosure.

FIG. 3 illustrates one embodiment of the present disclosure.

FIG. 4 illustrates a high-level diagram showing the components of an exemplary data-processing system for analyzing data and performing other analyses described herein, and related components.

FIG. 5 illustrates a system in accordance with one or more embodiments.

FIG. 6 illustrates a method of processing liquid.

FIG. 7 illustrates a system in accordance with one or more embodiments.

### DETAILED DESCRIPTION

In the following description, some aspects will be described in terms that would ordinarily be implemented as software programs. Those skilled in the art will readily recognize that the equivalent of such software can also be constructed in hardware, firmware, or micro-code. Because data-manipulation algorithms and systems are well known, the present description will be directed in particular to algorithms and systems forming part of, or cooperating more directly with, systems and methods described herein. Other aspects of such algorithms and systems, and hardware or software for producing and otherwise processing the signals involved therewith, not specifically shown or described herein, are selected from such systems, algorithms, components, and elements known in the art. Given the systems and methods as described herein, software not specifically shown, suggested, or described herein that is useful for implementation of any aspect is conventional and within the ordinary skill in such arts.

According to one aspect, the present disclosure provides a system and method for filtering ions from a liquid solution by passing the solution through a media having a plurality of nanopores, wherein an external voltage is applied to the filtering media, the external voltage causing an accumulation of charge at the nanopore's circumference, wherein the charge increases the effective filtering strength of the media as compared to the filtering strength when the external voltage is not present. The external voltage may be adjusted to increase or decrease the filtering strength of the media as desired. The thickness of the media is preferably on the order of a single atom or up to several tens of atoms thick.

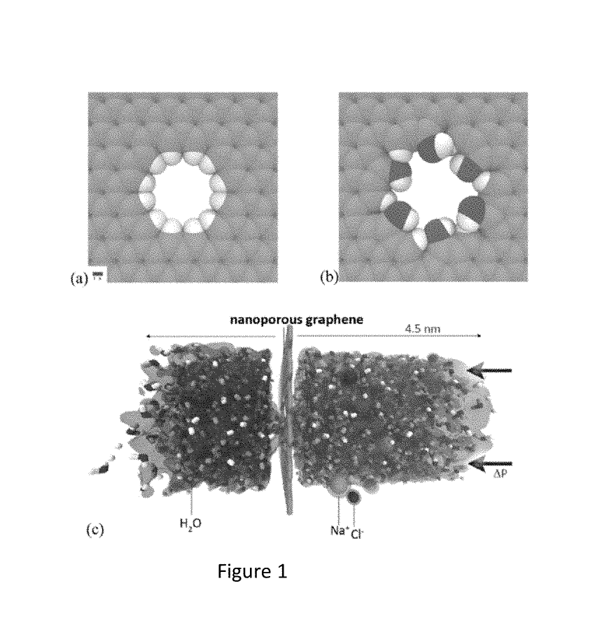

FIG. 1 shows one example of filtering media which contains nanopores for filtering ions from a liquid solution, such as saltwater. Ion filtration is maintained with pores that are small enough to block hydrated ions (FIG. 1). This technology benefits from the ultimate limit of the single-atom layer (or very thin) material. This supports a high water flow through the filter, since the water flow is approximately inverse proportional to the filter's thickness. It is found that nanoporous graphene can have a water permeability of 2-3 orders of magnitude higher than of commercial reverse osmosis membranes, while still maintaining a sufficient salt rejection rate (Nano Lett. 12, 3602-3608 (2012)).

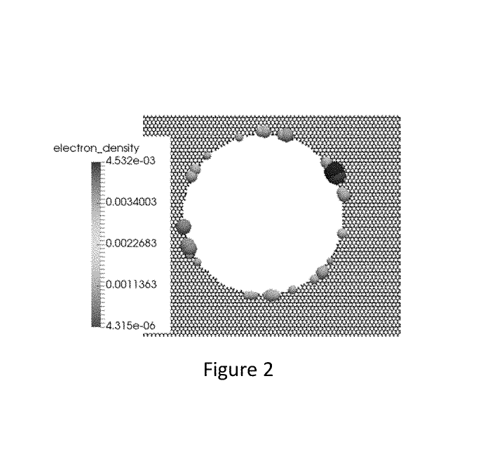

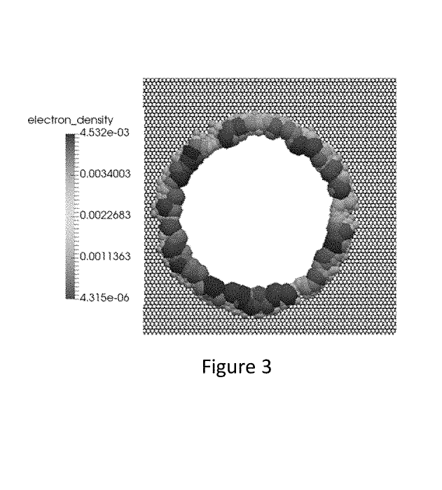

FIGS. 2 and 3 illustrate one embodiment of the present disclosure, wherein a tunable external voltage is applied to a generally 2D nanoporous filtering media. As shown, the permeability of the nanoporous 2D system is enhanced with wider pores than considered previously in the art (e.g., the maximum diameter for 100% salt-filtration 0.55 nm in Nano Lett. 12, 3602-3608 (2012)). To still maintain a sufficient salt ion rejection rate, the filtration effect of the nanopores can be enhanced with charge effects triggered by applying a voltage on the nanoporous material. In one example, atomistic resolved quantum simulations of the electronic properties of graphene based nanopores were performed with the nanodevice simulation tool NEMO5 (NEMO5-presenting article: e.g. IEEE Transactions on Nanotechnology 10, 1464 (2011)). FIGS. 2 and 3 compare the electron density around the nanopore in the device's center (note that the system is assumed in-plane periodic and represents an infinite mesh of equal nanopores). FIG. 2 shows the pore circumference of the voltage free nanoporous device. The atomistic quantum mechanical calculation of the electrons in the system does not show any significant charge distribution around the pore circumference. Therefore, water molecules as well as ions can pass the comparably wide-open filter. Illustrated in the example of FIG. 2 is the electron density around the circumference of a 10 nm wide graphene nanopore (other materials and diameters are possible) with the Fermi level set to the Dirac point (charge neutral point of the graphene). Electrons around the Fermi level are shown, background electrons are avoided to ease visibility. This configuration allows ions to flow through the pore. FIG. 3 shows the same pore with an applied voltage of 0.5V, which shifts the Fermi level of the system by 500 meV above the level of FIG. 2. Many electronic states in the then-occupied energy range are located on the circumference of the pore. In consequence, the inner area of the pore will experience a significant electric field (similar to those utilized in the inner surface of the pores in US20110168560A1). In the example of FIG. 3, the Fermi level is set to about 0.5 eV above the Dirac point. Electrons around the Fermi level are shown, background electrons of more than 40 meV below the Dirac point of Graphene are avoided to ease visibility. This configuration blocks ion to flow through the pore.

In certain embodiments, the absolute value of the external voltage applied to the filtering media may be in the range of 0.1-5.0 volts, depending on the needs of the application. In other embodiments, the voltage may be in the range of 0.4-0.6 volts. The voltage source may comprise a single electrode in contact with the filtration media, wherein the ground is then provided by the liquid solution (e.g., saltwater). In other embodiments, the substrate (e.g. a glass plate with a hole for the nanoporous filtration media) on which the nanoporous filtration media would sit on can be in contact with ground terminal of the voltage source. In still other embodiments, the two terminals of the voltage source would be connected to opposing ends of the filtration media.

The impact range of electric fields generated by plane surfaces into water is in the order of a single nanometer. Surface edge effects which enhance electric fields significantly will therefore enhance the penetration depth of the electric field of the pore circumference into the salt water further. Consequently, the presently disclosed system and method for charging pore circumferences will allow for wider nanopores while still effectively filtering ions.

Moreover, the voltage applied on the filter is tunable (may be increased or decreased). This allows the system to control the filter efficiency and therefore the ion-concentration of the filtered liquid. Processes in chemical engineering that involve ions in liquid solution (not only water, but any liquid) will benefit from the presently disclosed voltage-controllable ion filter.

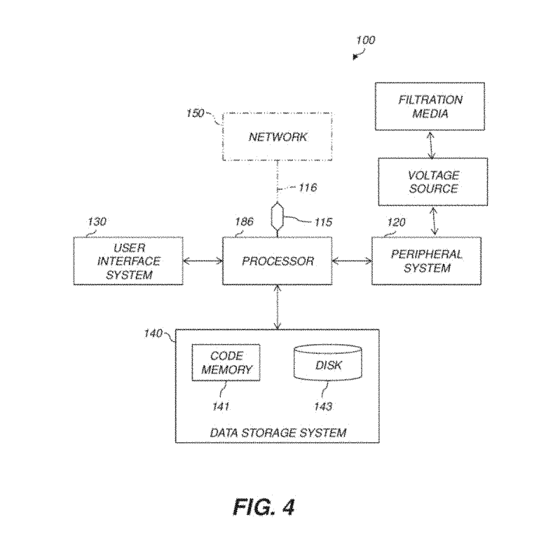

FIG. 4 is a high-level diagram showing the components of an exemplary data-processing system for analyzing data and performing other analyses described herein, and related components. The system includes a processor 186, a peripheral system 120, a user interface system 130, and a data storage system 140. The peripheral system 120, the user interface system 130 and the data storage system 140 are communicatively connected to the processor 186. Processor 186 can be communicatively connected to network 150 (shown in phantom), e.g., the Internet or a leased line, as discussed below. It shall be understood that the system 100 may include multiple processors 186 and other components shown in FIG. 1. The video content data, and other input and output data described in the Papers may be obtained using network 150 (from one or more data sources), peripheral system 120 and/or displayed using display units (included in user interface system 130) which can each include one or more of systems 186, 120, 130, 140, and can each connect to one or more network(s) 150. Processor 186, and other processing devices described herein, can each include one or more microprocessors, microcontrollers, field-programmable gate arrays (FPGAs), application-specific integrated circuits (ASICs), programmable logic devices (PLDs), programmable logic arrays (PLAs), programmable array logic devices (PALs), or digital signal processors (DSPs).

Processor 186 can implement processes of various aspects described herein. Processor 186 can be or include one or more device(s) for automatically operating on data, e.g., a central processing unit (CPU), microcontroller (MCU), desktop computer, laptop computer, mainframe computer, personal digital assistant, digital camera, cellular phone, smartphone, or any other device for processing data, managing data, or handling data, whether implemented with electrical, magnetic, optical, biological components, or otherwise. Processor 186 can include Harvard-architecture components, modified-Harvard-architecture components, or Von-Neumann-architecture components.

The phrase “communicatively connected” includes any type of connection, wired or wireless, for communicating data between devices or processors. These devices or processors can be located in physical proximity or not. For example, subsystems such as peripheral system 120, user interface system 130, and data storage system 140 are shown separately from the data processing system 186 but can be stored completely or partially within the data processing system 186.

The peripheral system 120 can include one or more devices configured to provide information to the processor 186. For example, the peripheral system 120 can include a variable voltage which is controlled by the processor, and which is further connected to the nanoporous filtration media described herein. The processor 186, upon receipt of information from a device in the peripheral system 120, can store such information in the data storage system 140.

The user interface system 130 can include a mouse, a keyboard, another computer (connected, e.g., via a network or a null-modem cable), or any device or combination of devices from which data is input to the processor 186. The user interface system 130 also can include a display device, a processor-accessible memory, or any device or combination of devices to which data is output by the processor 186. The user interface system 130 and the data storage system 140 can share a processor-accessible memory.

In various aspects, processor 186 includes or is connected to communication interface 115 that is coupled via network link 116 (shown in phantom) to network 150. For example, communication interface 115 can include an integrated services digital network (ISDN) terminal adapter or a modem to communicate data via a telephone line; a network interface to communicate data via a local-area network (LAN), e.g., an Ethernet LAN, or wide-area network (WAN); or a radio to communicate data via a wireless link, e.g., WiFi or GSM. Communication interface 115 sends and receives electrical, electromagnetic or optical signals that carry digital or analog data streams representing various types of information across network link 116 to network 150. Network link 116 can be connected to network 150 via a switch, gateway, hub, router, or other networking device.

Processor 186 can send messages and receive data, including program code, through network 150, network link 116 and communication interface 115. For example, a server can store requested code for an application program (e.g., a JAVA applet) on a tangible non-volatile computer-readable storage medium to which it is connected. The server can retrieve the code from the medium and transmit it through network 150 to communication interface 115. The received code can be executed by processor 186 as it is received, or stored in data storage system 140 for later execution.

Data storage system 140 can include or be communicatively connected with one or more processor-accessible memories configured to store information. The memories can be, e.g., within a chassis or as parts of a distributed system. The phrase “processor-accessible memory” is intended to include any data storage device to or from which processor 186 can transfer data (using appropriate components of peripheral system 120), whether volatile or nonvolatile; removable or fixed; electronic, magnetic, optical, chemical, mechanical, or otherwise. Exemplary processor-accessible memories include but are not limited to: registers, floppy disks, hard disks, tapes, bar codes, Compact Discs, DVDs, read-only memories (ROM), erasable programmable read-only memories (EPROM, EEPROM, or Flash), and random-access memories (RAMs). One of the processor-accessible memories in the data storage system 140 can be a tangible non-transitory computer-readable storage medium, i.e., a non-transitory device or article of manufacture that participates in storing instructions that can be provided to processor 186 for execution.

In an example, data storage system 140 includes code memory 141, e.g., a RAM, and disk 143, e.g., a tangible computer-readable rotational storage device such as a hard drive. Computer program instructions are read into code memory 141 from disk 143. Processor 186 then executes one or more sequences of the computer program instructions loaded into code memory 141, as a result performing process steps described herein. In this way, processor 186 carries out a computer implemented process. For example, steps of methods described herein, blocks of the flowchart illustrations or block diagrams herein, and combinations of those, can be implemented by computer program instructions. Code memory 141 can also store data, or can store only code.

Various aspects described herein may be embodied as systems or methods. Accordingly, various aspects herein may take the form of an entirely hardware aspect, an entirely software aspect (including firmware, resident software, micro-code, etc.), or an aspect combining software and hardware aspects These aspects can all generally be referred to herein as a “service,” “circuit,” “circuitry,” “module,” or “system.”

Furthermore, various aspects herein may be embodied as computer program products including computer readable program code stored on a tangible non-transitory computer readable medium. Such a medium can be manufactured as is conventional for such articles, e.g., by pressing a CD-ROM. The program code includes computer program instructions that can be loaded into processor 186 (and possibly also other processors), to cause functions, acts, or operational steps of various aspects herein to be performed by the processor 186 (or other processor). Computer program code for carrying out operations for various aspects described herein may be written in any combination of one or more programming language(s), and can be loaded from disk 143 into code memory 141 for execution. The program code may execute, e.g., entirely on processor 186, partly on processor 186 and partly on a remote computer connected to network 150, or entirely on the remote computer.

The invention is inclusive of combinations of the aspects described herein. References to “a particular aspect” and the like refer to features that are present in at least one aspect of the invention. Separate references to “an aspect” (or “embodiment”) or “particular aspects” or the like do not necessarily refer to the same aspect or aspects; however, such aspects are not mutually exclusive, unless so indicated or as are readily apparent to one of skill in the art. The use of singular or plural in referring to “method” or “methods” and the like is not limiting. The word “or” is used in this disclosure in a non-exclusive sense, unless otherwise explicitly noted.

The invention has been described in detail with particular reference to certain preferred aspects thereof, but it will be understood that variations, combinations, and modifications can be effected by a person of ordinary skill in the art within the spirit and scope of the invention.

The following disclosure provides many different embodiments, or examples, for implementing different features of the present application. Specific examples of components and arrangements are described below to simplify the present disclosure. These are examples and are not intended to be limiting. The making and using of illustrative embodiments are discussed in detail below. It should be appreciated, however, that the disclosure provides many applicable concepts that can be embodied in a wide variety of specific contexts. In at least some embodiments, one or more embodiment(s) detailed herein and/or variations thereof are combinable with one or more embodiment(s) herein and/or variations thereof.

Example embodiments in conjunction with the following, specific embodiments of the present invention will be further described. The following examples serve only to more clearly illustrate the technical solutions of the present invention, and are not intended to limit the scope of the invention.

### Example 1

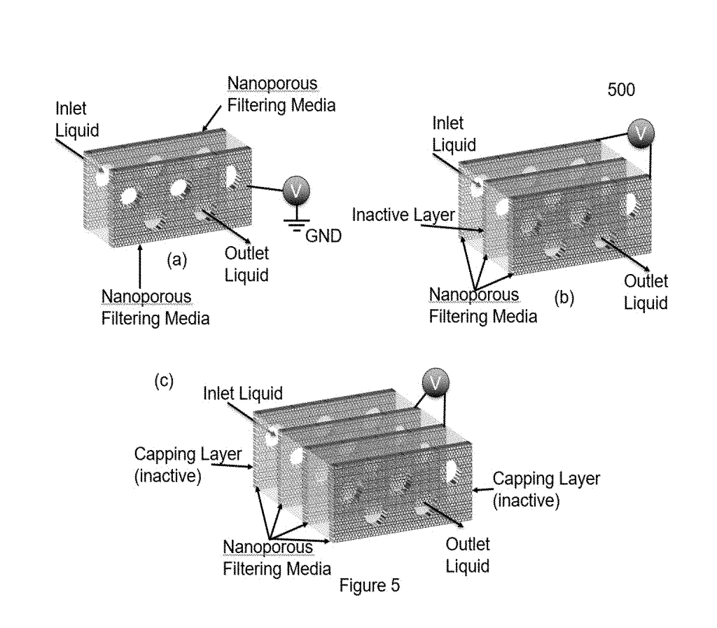

FIG. 5 illustrates a system 500 in accordance with one or more embodiments. In at least one embodiment, the system is a filtering system. The system includes a plurality of nanoporous filtering media, wherein each nanoporous filtering media of the plurality of nanoporous filtering media includes a plurality of nanopores. The plurality of nanoporous filtering media are stacked over each other.

The system further includes a voltage source connected to a nanoporous filtering media of the plurality of nanoporous filtering media, wherein the voltage source is configured to provide a voltage to the nanoporous filtering media of the plurality of nanoporous media. The voltage source is further configured to establish an electrostatic charge within a circumference of each nanopore of the plurality of nanopores of the nanoporous filtering media. In one or more embodiments, the voltage source which is connected to the nanoporous filtering media is a good conductor of electricity.

FIG. 5 additionally illustrates the plurality of nanoporous filtering media in accordance with one or more embodiments. The plurality of nanoporous filtering media includes at least two nanoporous filtering medias. In at least one embodiments, the plurality of nanoporous filtering media includes three nanoporous filtering medias. In some embodiments, the plurality of nanoporous filtering media includes at least four nanoporous filtering medias.

Each nanoporous filtering media of the plurality of nanoporous filtering media includes at least one of an intrinsic semiconductor, a doped semiconductor, a charge conducting nanoporous thin layer of silicon, germanium, a group III/V material, a group II/VI material, a material composed of group II, III, IV, V, and VI atoms, a metal, copper, a nanoporous 2D material, graphene, a transition metal dicalchogenide, hexagonal boron nitride, ZnO, or TiO2. In some embodiments, each nanoporous filtering media of the plurality of nanoporous filtering media are made of the same material, or of different materials. In at least one embodiment, the plurality of nanoporous filtering media includes at least one nanoporous filtering media connected to a voltage source (see FIG. 5), while the remaining nanoporous filtering media cap the at least one nanoporous filtering media by one or more sides. In some embodiments, a thickness of each nanoporous filtering media of the plurality of nanoporous filtering media ranges from 1 atomic layer to 100 atomic layer. In one or more embodiments, a diameter of each nanopores of the each nanoporous filtering media ranges from 0.2 nanometers to 20 nanometers. In at least one embodiment, an area of a pore of the nanoporous filtering media connected to the voltage source is greater than or equal to a pore of the nanoporous filtering media which is the capping layer (i.e. the capping layer isn't connected to the voltage source, because it provides mechanical separation).

Referring again to FIG. 5, the system includes the voltage source, where the voltage source is configured to produce a constant voltage. In some embodiments, the voltage source is configured to produce alternating voltage. In some embodiments, the alternating voltage is symmetrical. In some embodiments, the alternating voltage is asymmetrical. In at least one embodiment, the voltage source is configured to produce a constant voltage and an alternating voltage, within a unit of time.

### Example 2

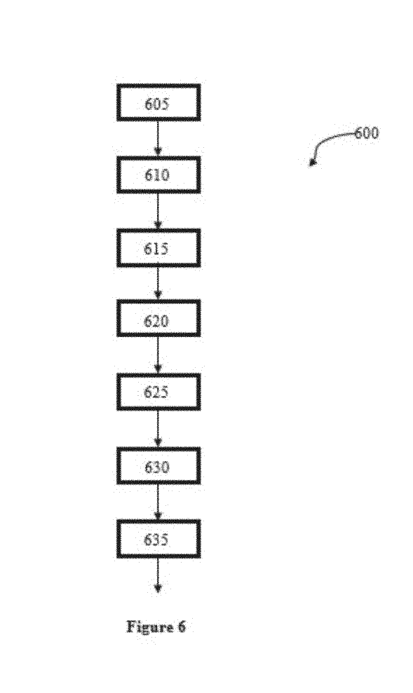

FIG. 6 illustrates a method of processing liquid 600, wherein the method includes mechanically filtering a first flow of liquid through a capping layer (605). Next, the method continues with receiving the first flow of liquid at a first interface of a nanoporous filtering media (610). The method further includes applying a voltage to at least one of the nanoporous filtering media (615). Next, the method includes inducing an electrostatic charge within a circumference of each nanopore of the nanoporous filtering media, thereby inducing a positive electrostatic charge or inducing a negative electrostatic charge (620). Additionally, the method includes collecting ionized liquid at the first interface of the nanoporous filtering media (625). Furthermore, the method includes receiving a second flow of liquid through the each nanopore of the nanoporous filtering media (630), wherein an ion concentration of the second flow of liquid is different than an ion concentration of the first flow of liquid. In some embodiments, the ion concentration of the second flow of liquid is less than the ion concentration of the first flow of liquid. The method also includes periodically draining the collected ionized fluid at the first interface of the nanoporous filtering media (635).

In some embodiments, the above method uses at least one of a continuous voltage or an alternating voltage, within a unit of time.

One of ordinary skill in the art would recognize that operations are added or removed from method 600, in one or more embodiments. One of ordinary skill in the art would also recognize that the order of the operations in method 600 is varied in various alternative embodiments.

### Example 3

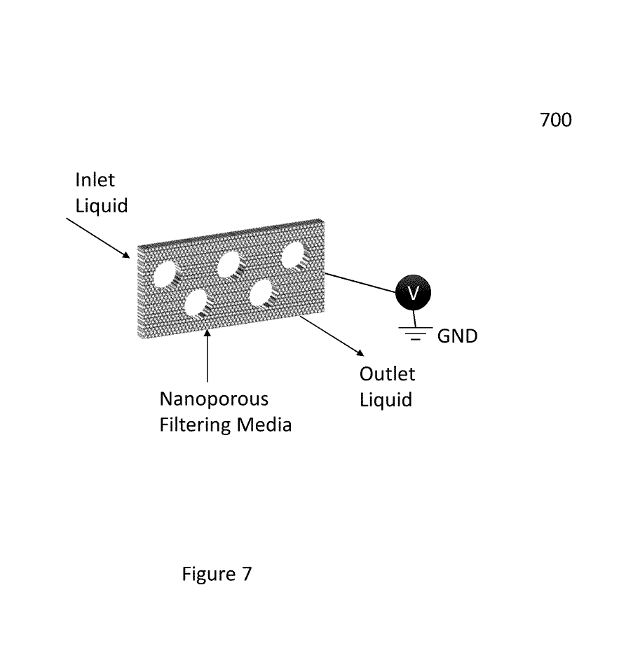

FIG. 7 illustrates a system 700 in accordance with one or more embodiments. In at least one embodiment, the system is a filtering system. The system includes a nanoporous filtering media. The system further includes a voltage source connected to the nanoporous filtering media, wherein the voltage source is configured to provide a voltage to the nanoporous filtering media. The voltage source is further configured to establish an electrostatic charge within a circumference of each nanopore of the plurality of nanopores of the nanoporous filtering media. In one or more embodiments, the voltage source which is connected to the nanoporous filtering media is a good conductor of electricity.

The nanoporous filtering media of the plurality of nanoporous filtering media includes an intrinsic semiconductor, a doped semiconductor, a charge conducting nanoporous thin layer of silicon, germanium, a group III/V material, a group II/VI material, a material composed of group II, III, IV, V, and VI atoms, a metal, copper, a nanoporous 2D material, graphene, a transition metal dicalchogenide, hexagonal boron nitride, ZnO, or TiO2. In some embodiments, a thickness of the nanoporous filtering media ranges from 1 atomic layer to 100 atomic layer. In one or more embodiments, a diameter of each nanopores of the nanoporous filtering media ranges from 0.2 nanometers to 20 nanometers.

The system of FIG. 7 includes the voltage source, where the voltage source is configured to produce a constant voltage. In some embodiments, the voltage source is configured to produce alternating voltage. In some embodiments, the alternating voltage is symmetrical. In some embodiments, the alternating voltage is asymmetrical. In at least one embodiment, the voltage source is configured to produce a constant voltage and an alternating voltage, within a unit of time.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, design, machine, manufacture, and composition of matter, means, methods and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

1. A system comprising:
a plurality of nanoporous filtering media, wherein each nanoporous filtering media of the plurality of nanoporous filtering media comprises a plurality of nanopores, wherein the plurality of nanoporous filtering media are stacked over each other; and
a voltage source connected to a nanoporous filtering media of the plurality of nanoporous filtering media, wherein the voltage source is configured to provide a voltage to the nanoporous filtering media of the plurality of nanoporous media, wherein the voltage source is configured to establish an electrostatic charge within a circumference of each nanopore of the plurality of nanopores of the nanoporous filtering media.

2. The system of claim 1, wherein the plurality of nanoporous filtering media comprises:
a first nanoporous filtering media stacked over a second nanoporous filtering media; and
the second nanoporous filtering media stacked over a third nanoporous filtering media.

3. The system of claim 2, wherein the first nanoporous filtering media comprises an intrinsic semiconductor, a doped semiconductor, a charge conducting nanoporous thin layer of silicon, germanium, a group III/V material, a group II/VI material, a material composed of group II, III, IV, V, and VI atoms, a metal, copper, a nanoporous 2D material, graphene, a transition metal dicalchogenide, hexagonal boron nitride, ZnO, or TiO₂.

4. The system of claim 2, wherein the second nanoporous filtering media comprises an intrinsic semiconductor, a doped semiconductor, a charge conducting nanoporous thin layer of silicon, germanium, a group III/V material, a group II/VI material, a material composed of group II, III, IV, V, and VI atoms, a metal, copper, a nanoporous 2D material, graphene, a transition metal dicalchogenide, hexagonal boron nitride, ZnO, or TiO₂.

5. The system of claim 2, wherein the third nanoporous filtering media comprises an intrinsic semiconductor, a doped semiconductor, a charge conducting nanoporous thin layer of silicon, germanium, a group III/V material, a group II/VI material, a material composed of group II, III, IV, V, and VI atoms, a metal, copper, a nanoporous 2D material, graphene, a transition metal dicalchogenide, hexagonal boron nitride, ZnO, or TiO₂.

6. The system of claim 1, wherein the voltage source is configured to produce a constant voltage.

7. The system of claim 1, wherein the voltage source is configured to product an alternating voltage.

8. The system of claim 7, wherein the alternating voltage is symmetrical.

9. The system of claim 7, wherein the alternating voltage is asymmetrical.

10. The system of claim 1, wherein the voltage source is configured to produce a constant voltage and an alternating voltage.

11. A system comprising:
a nanoporous filtering media, wherein the nanoporous filtering media comprises a plurality of nanopores; and
a voltage source connected to the nanoporous filtering media, wherein the voltage source is configured to provide a voltage to the nanoporous filtering media, wherein the voltage source is configured to establish an electrostatic charge within a circumference of each nanopore of the nanoporous filtering media.

12. The system of claim 11, wherein the nanoporous filtering media comprises an intrinsic semiconductor, a doped semiconductor, a charge conducting nanoporous thin layer of silicon, germanium, a group III/V material, a group II/VI material, a material composed of group II, III, IV, V, and VI atoms, a metal, copper, a nanoporous 2D material, graphene, a transition metal dicalchogenide, hexagonal boron nitride, ZnO, or TiO₂.

13. The system of claim 11, wherein the voltage source is configured to produce a constant voltage.

14. The system of claim 11, wherein the voltage source is configured to produce an alternating voltage.

15. The system of claim 14, wherein the alternating voltage is symmetrical.

16. The system of claim 14, wherein the alternating voltage is asymmetrical.

17. The system of claim 11, wherein the voltage source is configured to produce a constant voltage and an alternating voltage, within a unit of time.

18. A method of processing liquid, wherein the method comprises:
receiving a first flow of liquid at a first interface of a nanoporous filtering media;
applying a voltage to the nanoporous filtering media;
inducing an electrostatic charge within a circumference of each nanopore of the nanoporous filtering media;
collecting ionized liquid at the first interface of the nanoporous filtering media; and
receiving a second flow of liquid through the each nanopore of the nanoporous filtering media, wherein an ion concentration of the second flow of liquid is different than an ion concentration of the first flow of liquid.

19. The method of claim 18, wherein the applying the voltage to the nanoporous filtering comprises applying at least one of a continuous voltage or an alternating voltage, within a unit of time.

20. The method of claim 18, wherein the inducing the electrostatic charge within the circumference of the each nanopore of the nanoporous filtering media comprises inducing a positive electrostatic charge or inducing a negative electrostatic charge.

21. The method of claim 18, further comprising periodically draining the collected ionized fluid at the first interface of the nanoporous filtering media.

22. The method of claim 18, further comprising mechanically filtering the first flow of liquid through a capping layer, wherein the first flow of liquid is mechanically filtered before being received by the nanoporous filtering media.
